(19) United States
(12) Patent Application Publication
(10) Pub. No.: US 2019/0273731 A1
(43) Pub. Date: Sep. 5, 2019

(54) Securing Authentication Processes

(71) Applicant: Silverfort Ltd., Tel Aviv (IL)

(72) Inventors: Yaron Kassner, Hod Hasharon (IL); Matan Binyamin Fattal, Raanana (IL); Hed Kovetz, Atzmon-Segev (IL); Rotem Zach, Pardesiya (IL)

(21) Appl. No.: 16/419,017

(22) Filed: May 22, 2019

Related U.S. Application Data
(63) Continuation-in-part of application No. PCT/IB2017/057337, filed on Nov. 22, 2017.
(60) Provisional application No. 62/425,092, filed on Nov. 22, 2016.

(51) Int. Cl. H04L 29/06; H04L 12/741

(52) U.S. Cl. CPC H04L 63/08; H04L 63/0272; H04L 45/74; H04L 63/0464; H04L 63/164

(57) ABSTRACT

A method includes receiving a message belonging to an access request or to a response to the access request, the access request originating from a request-origin device and directed to a request-destination application. The method further includes, without using the request-destination application, subsequently to receiving the message, forwarding the message to a traffic-management server before communicating the message to a destination of the message, subsequently to forwarding the message, receiving the message from the traffic-management server, and subsequently to receiving the message from the traffic-management server, communicating the message to the destination of the message. Other embodiments are also described.

### CROSS-REFERENCE TO RELATED APPLICATIONS

The present application is a continuation-in-part of, and claims the benefit of, International Patent Application PCT/IB2017/057337, published as WO/2018/096471, entitled “Automatic forwarding of access requests and responses thereto,” filed Nov. 22, 2017, which claims the benefit of U.S. Provisional Application 62/425,092, entitled “Authentication Firewall,” filed Nov. 22, 2016. The respective disclosures of the aforementioned applications are incorporated herein by reference.

### FIELD OF THE INVENTION

The present invention relates generally to computer networks, and specifically to computer-network security.

### BACKGROUND

U.S. Pat. No. 10,154,049 describes an attack/unwanted activity detecting firewall for use in protecting authentication-based network resources. The system is adapted for installation inline or in sniffer mode. In various embodiments, defined rules are applied to network traffic to determine whether certain types of attacks are occurring on the network resources. If one such attack is detected, the system provides for several potential responses, including for example disconnecting the attacking remote machine, requiring the user at that machine to re-authenticate, and/or requiring a second factor of authentication from the user at that machine. In some example embodiments, regardless of any activity required of a user at the remote machine suspected of malicious behavior, the system generates an alarm or other alert for presentation as appropriate, such as via a graphical user interface or a third-party system using an API.

US Patent Application Publication 2016/0014077 describes a method, system, and computer program product for protecting Directory Services (DS) by monitoring traffic to the DS; deciding to block a client access request in the monitored traffic originating from a network client; synthesizing an error message based at least in part on the client access request; and sending the synthesized error message to the network client, causing the network client to abort access request process such as an authentication process or an authorization process.

U.S. Pat. No. 9,148,405 describes a multifactor authentication (MFA) enforcement server that provides multifactor authentication services to users and existing services. During registration, the MFA enforcement server changes a user's password on an existing service to a password unknown to the user. During normal usage when the user accesses the existing service through the MFA enforcement server, the MFA enforcement server enforces a multifactor authentication enforcement policy.

### SUMMARY OF THE INVENTION

There is provided, in accordance with some embodiments of the present invention, an apparatus including a communication interface and a processor. The processor is configured to run a request-destination application and, without using the request-destination application, receive a message belonging to an access request or to a response to the access request, the access request originating from a request-origin device and directed to the request-destination application, subsequently to receiving the message, forward the message, via the communication interface, to a traffic-management server before communicating the message to a destination of the message, subsequently to forwarding the message, receive the message from the traffic-management server, and subsequently to receiving the message from the traffic-management server, communicate the message to the destination of the message.

In some embodiments, the message belongs to the access request, such that the destination of the message is the request-destination application.

In some embodiments, the message belongs to the response to the access request, such that the destination of the message is the request-origin device.

In some embodiments, the processor is configured to forward the message by executing software that is not specialized for forwarding to the traffic-management server.

In some embodiments, the software includes Routing and Remote Access Service (RRAS) software.

In some embodiments, the software includes a destination network address translator (DNAT), and the processor is configured to, using the DNAT, set a destination Internet Protocol (IP) address in the forwarded message to an IP address of the traffic-management server.

In some embodiments, the processor is further configured to open a Virtual Private Network (VPN) tunnel with the traffic-management server, and the processor is configured to forward and receive the message through the VPN tunnel.

In some embodiments, the access request includes an authentication request, and the request-destination application includes a directory application.

In some embodiments, the request-destination application is selected from the group of applications consisting of: a Kerberos Key Distribution Center, an NT Local Area Network Manager (NTLM) authentication handler, a Netlogon authentication handler, and a Lightweight Directory Access Protocol (LDAP) directory application.

In some embodiments, the processor is configured to forward the message by executing network-layer software.

There is further provided, in accordance with some embodiments of the present invention, apparatus for intervening in an authentication process between a request-origin device and a directory application. The apparatus includes a communication interface and a processor. The processor is configured to receive, via the communication interface, an encrypted message belonging to the authentication process by virtue of belonging to (i) an authentication request originating from the request-origin device and directed to the directory application, or (ii) a response to the authentication request. The processor is further configured to, without using the directory application, decrypt the message, subsequently to decrypting the message, process the message, and in response to processing the message, intervene in the authentication process.

In some embodiments, the directory application is run on a directory server, and the processor does not belong to the request-origin device and does not belong to the directory server.

In some embodiments, the processor is configured to intervene in the authentication process by:

modifying the message,

subsequently to modifying the message, re-encrypting the message, and

subsequently to re-encrypting the message, sending the message to a device selected from the group of devices consisting of: the request-origin device, and the directory server.

In some embodiments, the message belongs to the authentication request, and the processor is configured to send the message to the directory server using an Internet Protocol (IP) address of the request-origin device as a source IP address of the message.

In some embodiments, the processor is configured to intervene in the authentication process by requesting provision of authentication from a user who initiated the authentication request.

In some embodiments, the authentication process is in accordance with a protocol selected from the group of protocols consisting of: Kerberos, NT Local Area Network Manager (NTLM), Netlogon, and Lightweight Directory Access Protocol (LDAP).

There is further provided, in accordance with some embodiments of the present invention, an apparatus for intervening in an authentication process between a request-origin device and a directory application. The apparatus includes a communication interface and a processor. The processor is configured to receive a message belonging to the authentication process by virtue of belonging to (i) an authentication request originating from the request-origin device and directed to the directory application, or (ii) a response to the authentication request, the message being encrypted using an encrypted Active Directory authentication protocol. The processor is further configured to, without using the directory application, in response to receiving the message, process the message, and in response to processing the message, request, via the communication interface, provision of authentication from a user who initiated the authentication request.

In some embodiments, the directory application is run on a directory server, and the processor does not belong to the request-origin device and does not belong to the directory server.

In some embodiments, the protocol is selected from the group of protocols consisting of: Netlogon, Lightweight Directory Access Protocol over Secure Sockets Layer (LDAPS), and Flexible Authentication Secure Tunneling (FAST).

There is further provided, in accordance with some embodiments of the present invention, a method including receiving a message belonging to an access request or to a response to the access request, the access request originating from a request-origin device and directed to a request-destination application. The method further includes, without using the request-destination application, subsequently to receiving the message, forwarding the message to a traffic-management server before communicating the message to a destination of the message, subsequently to forwarding the message, receiving the message from the traffic-management server, and subsequently to receiving the message from the traffic-management server, communicating the message to the destination of the message.

There is further provided, in accordance with some embodiments of the present invention, a method for intervening in an authentication process between a request-origin device and a directory application. The method includes receiving an encrypted message belonging to the authentication process by virtue of belonging to (i) an authentication request originating from the request-origin device and directed to the directory application, or (ii) a response to the authentication request. The method further includes, without using the directory application, decrypting the message, subsequently to decrypting the message, processing the message, and in response to processing the message, intervening in the authentication process.

In some embodiments, the message belongs to the authentication request, and receiving the message includes receiving the message from the request-origin device.

In some embodiments, receiving the message from the request-origin device includes receiving the message, by a traffic-management server, from the request-origin device by virtue of the request-origin device using the traffic-management server as a proxy for the directory server.

In some embodiments, receiving the message from the request-origin device includes receiving the message, by a traffic-management server, from the request-origin device by virtue of a Domain Name System (DNS) returning an Internet Protocol (IP) address of the traffic-management server in lieu of an IP address of the directory server.

In some embodiments, the directory application is run on a directory server, and receiving the message includes receiving the message from the directory server.

In some embodiments, the message belongs to the authentication request, and receiving the message from the directory server includes receiving the message, by a traffic-management server, from the directory server by virtue of the directory server forwarding the message to the traffic-management server in response to receiving the message from the request-origin device.

In some embodiments, the message belongs to the response, and receiving the message from the directory server includes receiving the message from the directory server with an Internet Protocol (IP) address of the request-origin device as a destination IP address of the message.

There is further provided, in accordance with some embodiments of the present invention, a method for intervening in an authentication process between a request-origin device and a directory application. The method includes receiving a message belonging to the authentication process by virtue of belonging to (i) an authentication request originating from the request-origin device and directed to the directory application, or (ii) a response to the authentication request, the message being encrypted using an encrypted Active Directory authentication protocol. The method further includes, without using the directory application, in response to receiving the message, processing the message, and in response to processing the message, requesting provision of authentication from a user who initiated the authentication request.

There is further provided, in accordance with some embodiments of the present invention, an apparatus that includes a network interface and a processor. The processor is configured to run a request-destination application and, by executing network-layer software that does not include the request-destination application, (i) receive, via the network interface, a request, originating from a request-origin device, to access a resource, the request being directed to the request-destination application, (ii) subsequently to receiving the request, decide to forward the request to a traffic-management server before communicating the request to the request-destination application, (iii) in response to the deciding, forward the request, over a computer network, to the traffic-management server, (iv) subsequently to forwarding the request, receive the request from the traffic-management server, and (v) subsequently to receiving the request from the traffic-management server, communicate the request to the request-destination application.

In some embodiments, the processor is configured to cause the traffic-management server to request authentication from a user of the request-origin device, by forwarding the request to the traffic-management server.

In some embodiments, the processor is further configured to, by executing the network-layer software:

receive, from the request-destination application, a response to the request, the response being directed to the request-origin device,

subsequently to receiving the response, decide to forward the response to the traffic-management server before communicating the response to the request-origin device,

in response to the deciding, forward the response, over the computer network, to the traffic-management server,

subsequently to forwarding the response, receive the response from the traffic-management server, and

subsequently to receiving the response from the traffic-management server, communicate the response to the request-origin device.

In some embodiments, the processor is configured to cause the traffic-management server to request authentication from a user of the request-origin device, by forwarding the response to the traffic-management server.

In some embodiments, the processor is configured to receive the response from the traffic-management server after the response has been modified by the traffic-management server.

In some embodiments, the processor is configured to receive the request from the traffic-management server after the request has been modified by the traffic-management server.

In some embodiments, the processor is configured to forward the request to the traffic-management server through a Virtual Private Network (VPN) tunnel.

In some embodiments, the resource is selected from the group of resources consisting of: a Kerberos Key Distribution Center, an NT Local Area Network Manager authentication handler, a Netlogon authentication handler, a Lightweight Directory Access Protocol directory service, and a webserver.

In some embodiments, the software includes a network address translator (NAT).

In some embodiments, the software includes port-forwarding software.

In some embodiments, the software includes a driver.

In some embodiments, the software includes routing software.

In some embodiments, the processor is further configured to:

communicate, to the traffic-management server, a health-test request, and

subsequently to communicating the health-test request, by executing the network-layer software:
receive, from the traffic-management server, a test access-request message that simulates the request to access the resource, and
forward the test access-request message to the traffic-management server.

There is further provided, in accordance with some embodiments of the present invention, an apparatus that includes a network interface and a processor. The processor is configured to run a request-destination application, and, by executing network-layer software that does not include the request-destination application, (i) receive, from the request-destination application, a response to a request to access a resource, the request originating from a request-origin device, and the response being directed to the request-origin device, (ii) subsequently to receiving the response, decide to forward the response to a traffic-management server before communicating the response to the request-origin device, (iv) in response to the deciding, forward the response via the network interface, over a computer network, to the traffic-management server, (v) subsequently to forwarding the response, receive the response from the traffic-management server, and (vi) subsequently to receiving the response from the traffic-management server, communicate the response to the request-origin device.

There is further provided, in accordance with some embodiments of the present invention, an apparatus that includes a network interface and a processor. The processor is configured to receive via the network interface, over a computer network, from one of a request-origin device and a request-destination device, a request, originating from the request-origin device, to access a resource, the request being directed to the request-destination device. The processor is further configured to process the received request, and, subsequently to processing the request, to return the request to the one of the request-origin device and the request-destination device.

In some embodiments, the processor is configured to:

receive the request from the request-destination device, and

return the request to the request-destination device under an identifier of the request-origin device, such that the returned request appears, to the request-destination device, to have been received from the request-origin device.

In some embodiments, the processor is further configured to:

receive over the computer network, from the one of the request-origin device and the request-destination device, a response to the request, the response being directed to the request-origin device,

process the received response, and

subsequently to processing the response, return the response to the one of the request-origin device and the request-destination device.

In some embodiments,

the processor is configured to, in processing the received response, decide, based on content of the received response, to request authentication from a user of the request-origin device, and

the processor is further configured to, in response to the deciding, request the authentication.

In some embodiments, the one of the request-origin device and the request-destination device is a first one of the request-origin device and the request-destination device, and the processor is further configured to:

receive over the computer network, from a second one of the request-origin device and the request-destination device, a response to the request, the response being directed to the request-origin device,

process the received response, and

subsequently to processing the response, return the response to the second one of the request-origin device and the request-destination device.

In some embodiments,

the processor is configured to, in processing the received request, decide, based on content of the received request, to deny the request, and

the processor is further configured to:
receive over the computer network, from the one of the request-origin device and the request-destination device, a response indicating that the request was granted, the response being directed to the request-origin device,
in response to the deciding, modify the response to indicate that the request was denied, and
subsequently to modifying the response, return the response to the one of the request-origin device and the request-destination device.

In some embodiments,

the processor is configured to, in processing the received request, decide, based on content of the received request, to request authentication from a user of the request-origin device, and

the processor is further configured to, in response to the deciding, request the authentication.

In some embodiments, the processor is further configured to:

receive over the computer network, from the one of the request-origin device and the request-destination device, a response to the request, the response being directed to the request-origin device, and

ascertain that the response indicates that the request was granted, and

the processor is configured to request the authentication in response to the ascertaining.

In some embodiments, the processor is further configured to:

in response to not receiving the requested authentication, modify the response to indicate that the request was denied, and

subsequently to modifying the response, return the response to the one of the request-origin device and the request-destination device.

In some embodiments, the processor is configured to, in processing the received request, modify the received request.

In some embodiments, the resource is selected from the group of resources consisting of: a Kerberos Key Distribution Center, an NT Local Area Network Manager authentication handler, a Netlogon authentication handler, a Lightweight Directory Access Protocol directory service, and a webserver.

In some embodiments, the processor is further configured to:

receive, from the one of the request-origin device and the request-destination device, a health-test request, and

subsequently to receiving the health-test request, communicate, to the one of the request-origin device and the request-destination device, a test access-request message, which simulates the request to access the resource.

There is further provided, in accordance with some embodiments of the present invention, an apparatus that includes a network interface and a processor. The processor is configured to receive via the network interface, over a computer network, from one of a request-origin device and a request-destination device, a response to a request to access a resource, the request originating from the request-origin device, and the response being directed to the request-origin device. The processor is further configured to process the received response, and, subsequently to processing the response, to return the response to the one of the request-origin device and the request-destination device.

There is further provided, in accordance with some embodiments of the present invention, an apparatus that includes a network interface and a processor. The processor is configured to run a request-origin application, and, by executing network-layer software that does not include the request-origin application, (i) receive a request, originating from the request-origin application, to access a resource, the request being directed to a request-destination device, (ii) subsequently to receiving the request, decide to forward the request to a traffic-management server before communicating the request to the request-destination device, (iii) in response to the deciding, forward the request via the network interface, over a computer network, to the traffic-management server, (iv) subsequently to forwarding the request, receive the request from the traffic-management server, and (v) subsequently to receiving the request from the traffic-management server, communicate the request to the request-destination device.

There is further provided, in accordance with some embodiments of the present invention, a method that includes receiving, at a network layer of one of a request-origin device and a request-destination device, a request, originating from a request-origin application running on the request-origin device, to access a resource, the request being directed to a request-destination application running on the request-destination device. The method further includes, subsequently to receiving the request, by executing software that runs at the network layer, (i) deciding to forward the request to a traffic-management server before communicating the request to the request-destination application, (ii) in response to the deciding, forwarding the request from the network layer, over a computer network, to the traffic-management server, (iii) subsequently to forwarding the request, receiving the request, at the network layer, from the traffic-management server, and (iv) subsequently to receiving the request from the traffic-management server, communicating the request to the request-destination application.

There is further provided, in accordance with some embodiments of the present invention, a method that includes receiving from a request-destination application running on a request-destination device, at a network layer of one of a request-origin device and the request-destination device, a response to a request to access a resource, the request originating from a request-origin application running on the request-origin device, and the response being directed to the request-origin application. The method further includes, subsequently to receiving the response, by executing software that runs at the network layer, (i) deciding to forward the response to a traffic-management server before communicating the response to the request-origin application, (ii) in response to the deciding, forwarding the response from the network layer, over a computer network, to the traffic-management server, (iii) subsequently to forwarding the response, receiving the response, at the network layer, from the traffic-management server, and (iv) subsequently to receiving the response from the traffic-management server, communicating the response to the request-origin application.

There is further provided, in accordance with some embodiments of the present invention, a method that includes receiving over a computer network, by a traffic-management server, from one of a request-origin device and a request-destination device, a request, originating from the request-origin device, to access a resource, the request being directed to the request-destination device. The method further includes processing the received request, and, subsequently to processing the request, returning the request to the one of the request-origin device and the request-destination device.

There is further provided, in accordance with some embodiments of the present invention, a method that includes receiving over a computer network, by a traffic-management server, from one of a request-origin device and a request-destination device, a response to a request to access a resource, the request originating from the request-origin device, and the response being directed to the request-origin device. The method further includes processing the received response, and, subsequently to processing the response, returning the response to the one of the request-origin device and the request-destination device.

There is further provided, in accordance with some embodiments of the present invention, a method for handling a request to access a resource, the request originating from a request-origin device and being directed to a request-destination application running on a request-destination device. The method includes forwarding the request, from one of the request-origin device and the request-destination device, to a traffic-management server, before communicating the request to the request-destination application. The method further includes, using the traffic-management server, receiving the request from the one of the request-origin device and the request-destination device, processing the received request, and, subsequently to processing the request, returning the request to the one of the request-origin device and the request-destination device. The method further includes, using the one of the request-origin device and the request-destination device, receiving the returned request from the traffic-management server, and, subsequently to receiving the request from the traffic-management server, communicating the request to the request-destination application.

The present invention will be more fully understood from the following detailed description of embodiments thereof, taken together with the drawings, in which:

### BRIEF DESCRIPTION OF THE DRAWINGS

FIG. 1 is a schematic illustration of a system for managing access requests and the responses to such requests, in accordance with some embodiments of the present invention;

FIG. 2 is a schematic illustration of a flow of communication between a client, a server, and a traffic-management server, in accordance with some embodiments of the present invention;

FIG. 3 is a schematic illustration of an alternate flow of communication between the client, the server, and the traffic-management server, in accordance with some embodiments of the present invention;

FIG. 4 is a schematic illustration of a flow diagram for a method for implementing a multi-factor authentication policy, in accordance with some embodiments of the present invention; and

FIG. 5 is a schematic illustration of the internal architecture of a traffic-management server, in accordance with some embodiments of the present invention.

### DETAILED DESCRIPTION OF EMBODIMENTS

### Overview

In many computer networks, such as a local area network (LAN), a directory, which is implemented using an Active Directory Domain Services (ADDS) application or another directory application, manages access to resources in the network. In such networks, to access a resource hosted by one of the servers in the network, a client submits an access request to the server. In response to the access request, the server submits an authentication request to a directory server, such as a Domain Controller (DC), that hosts the directory (i.e., that runs the directory application), thereby requesting that the client be authenticated. If the directory approves the authentication request and the user is authorized, the client is allowed to access the resource.

In such networks, it is generally challenging to defend against password-based attacks in which a malicious agent uses stolen credentials, such as a stolen password, to authenticate itself to the directory. In particular, although solutions such as multi-factor authentication (MFA) are helpful in defending against these types of attacks in other contexts, it may be difficult to implement these solutions in this particular context.

To further explicate the issue, it is noted that some MFA solutions integrate directly with the protected system. Alternatively, MFA is sometimes achieved by putting a proxy between the client and the server or by installing an agent on the server. However, not all systems may support installation of agents. The proxy approach has limitations as well, because it can only protect authentication messages that go through the proxy, and the network must be micro-segmented to cover all sensitive client-server flows with proxies. Integration with each system is not possible, because many systems do not support MFA by default. An alternative approach could be to integrate with the identity provider or the directory, but some directories do not have built-in integration with modern MFA providers. For example, Active Directory and some other Lightweight Directory Access Protocol (LDAP) directories do not provide MFA for access to individual resources, and do not support MFA with push notifications to a smartphone.

To address this challenge, embodiments of the present invention place a network-security system, physically or logically, in front of the directory, such that all authentication-related flows with the directory pass through the system. The network-security system, which typically comprises a separate server referred to hereinbelow as a traffic-management server (TMS), is configured to process messages belonging to the authentication-related flows and, if necessary, implement additional security measures, such as MFA, so as to thwart any potential password-based attacks. For example, the network-security system may:

(i) receive each authentication request before the request reaches the directory,

(ii) ascertain relevant parameters of the request, such as the identity of the user who initiated the request, the resource to which access is requested, relevant network addresses included in the request, and the time of the request,

(iii) if appropriate, modify the request, require additional authentication from the user, and/or apply any other suitable security measures,

(iv) subsequently to processing the request, pass the request to the directory,

(v) receive the response to the request, before the response reaches the device that submitted the authentication request,

(vi) inspect the response, and, if the response indicates that the requested access was granted, decide whether any security measures are required,

(vii) if appropriate, modify the response, require additional authentication from the user, and/or implement any other suitable security measures, and

(viii) pass the response to the device that submitted the authentication request.

Embodiments of the present invention further provide techniques to route authentication-related flows through the network-security system. For example, the network-security system may be situated inline, i.e., the network-security system may reside physically or logically between the servers that generate the authentication requests and the DC. By virtue of being situated inline, all communication exchanged with the DC passes through the network-security system. Thus, the network-security system may handle relevant authentication-related flows, while other communication may be forwarded transparently to the intended destination.

Alternatively, each message belonging to an authentication request, and/or each message belonging to a response to an authentication request, may be forwarded to the TMS by the DC before the message is passed to its intended destination. Advantageously, this forwarding may be initiated and performed by one or more modules (or “components”) that are separate from the directory application, such as hardware and/or software that operates at the network layer of the DC. Thus, a single, central forwarding infrastructure may handle authentication-related messages of multiple varying types, without the need for any modifications (or at least without the need for any significant modifications) to the directory application. Moreover, the aforementioned modules may include software that is native to the DC, such as Routing and Remote Access Service (RRAS) and/or any other suitable routing or virtual private network (VPN) software. Thus, the relevant messages may be passed to the TMS even if the administrator of the DC forbids the installation of third-party software on the DC. Furthermore, in the event that the TMS is unresponsive, inoperative, or dysfunctional, the DC may simply cease forwarding to the TMS, or may forward to a different server, such that users may continue accessing network resources. Another advantage of this technique is that the technique allows the TMS to reside outside of the network; for example, the functionality of the TMS may be implemented as a cloud service. Moreover, this technique is easily scalable to multiple directories, and to multiple directory servers spread over various locations.

For example, the network layer of the DC may be configured to forward certain received authentication requests to the TMS, instead of directly passing these requests to the directory application that handles such requests. Subsequently to receiving such a forwarded request, the TMS may ascertain relevant parameters of the request, and then ascertain, based on these parameters, whether to allow the request, block the request, or require additional authentication before making this decision. Subsequently to processing the forwarded request, the TMS may return the request to the network layer of the DC. The network layer may then pass the request to the directory application.

In some embodiments, the DC passes each request to the TMS using, as the source IP address, the IP address of the server that generated the request, rather than the IP address of the DC. This may be done, for example, using VPN software in combination with destination network address translator (DNAT) software, the request being sent to the TMS, and received from the TMS, over a VPN tunnel. This helps the TMS identify the server that generated the request, and thus make better decisions regarding any required MFA procedures.

Alternatively or additionally, the request may be returned to the DC by the TMS using the IP address of the server as the source IP address, such that the directory application does not realize that the request was received from the TMS. Alternatively, prior to passing the request to the directory application, the network layer of the DC may change the source IP address to the IP address of the server. The directory application may thus continue logging the same IP addresses as before the implementation of forwarding to the TMS.

Alternatively or additionally, in response to receiving a response to an authentication request from the directory application, the network layer of the DC may forward the response to the TMS, instead of sending the response directly to the server that generated the request. If the response indicates that authentication was granted, and if the TMS previously ascertained, or currently ascertains, that additional authentication is required, the TMS may ask the user to provide additional authentication. If the TMS does not receive the required authentication, the TMS may modify the response to indicate a denial of the request. Subsequently, the TMS may return the response to the network layer of the DC, for forwarding to the server that generated the request.

Another challenge addressed by embodiments of the present invention is that the authentication-related flows exchanged with the directory are typically encrypted using encrypted Active Directory authentication protocols or other encrypted protocols; examples of such protocols include Netlogon, Lightweight Directory Access Protocol over Secure Sockets Layer (LDAPS), and Flexible Authentication Secure Tunneling (FAST), which is used to encrypt some Kerberos authentication requests. This encryption obfuscates information that may be needed to enforce MFA, such as the identity being assumed by the user requesting access to the resource.

In some embodiments, to address this challenge, the network-security system is configured to acquire the keys that are needed to decrypt the flows, and to use these keys to decrypt the flows. In other embodiments, rather than decrypting the authentication-related flows, the network-security system uses unencrypted log entries to infer the content of the flows, as described, for example, in International Patent Application PCT/IB2018/054491, whose disclosure is incorporated herein by reference. For example, the network-security system may be configured to retrieve Windows Event Log entries from the DC, and to ascertain, from the entries, relevant parameters of each authentication request.

In addition to messages belonging to an authentication process (by virtue of belonging to an authentication request or to a response thereto), the techniques described herein may be applied to any message belonging to a request to access a network resource or to a response to such a request. In view of this, the description below uses the broader term “access request” in lieu of “authentication request.” In the context of the present application, including the claims, the term “access request” may include, within its scope, any request to access a network resource, along with any authentication request.

Moreover, in addition to a directory server, the techniques described herein may be performed with any other type of server that handles access requests, such as an identity provider server or a webserver, which may operate in any type of computing environment. Hence, the description and claims herein may use the term “server” or “request-destination device” rather than “directory server” or “DC,” and the term “request-destination application” rather than “directory application.” Accordingly, to avoid confusion, the device that generates the access request (such as a server that generates an authentication request) is referred to as the “client” or “request-origin device.” This terminology also accounts for the fact that in some cases, the “true” client—i.e., the device used by the user—communicates directly with the directory server. For example, for Kerberos ticket requests, the client communicates directly with the key distribution center (KDC).

In the context of the present application, including the claims, a “directory application” may refer to any application that, when run by a processor, implements the functionality of a directory.

### System Description

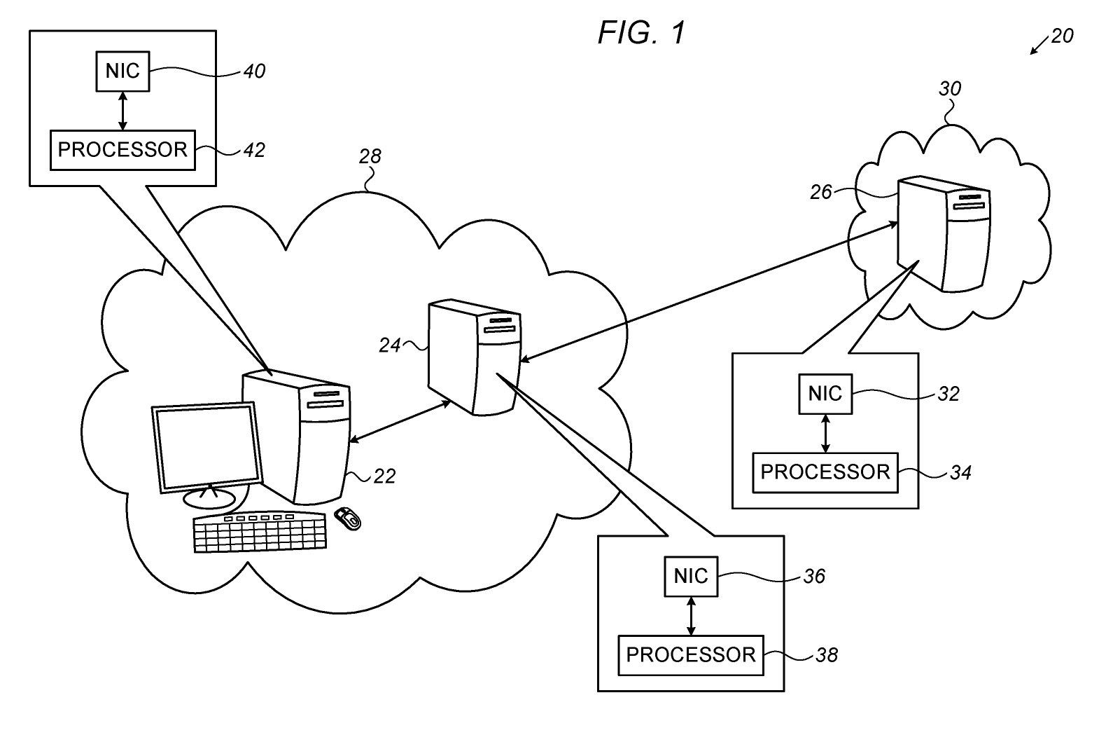

Reference is initially made to FIG. 1, which is a schematic illustration of a system 20 for managing access requests and the responses to such requests, in accordance with some embodiments of the present invention.

In the example scenario depicted in FIG. 1, a client 22 and a server 24 belong to a local area network (LAN) 28, such as a LAN belonging to a workplace. Client 22 may include, for example, a workstation belonging to a user, which the user may use to communicate access requests to server 24. Alternatively, as described above in the Overview, client 22 may comprise a device configured to receive access requests from another device and, in response thereto, communicate authentication requests to server 24. Client 22 comprises a communication interface, such as a NIC 40 or another network interface, and a processor 42. Processor 42 exchanges communication with server 24, and with other devices, via NIC 40.

In some embodiments, server 24 comprises a KDC or a webserver. In other embodiments, server 24 comprises a DC, another directory server, or an identity provider server. For example, server 24 may be configured to run an ADDS application or any other suitable directory application, such as an NT LAN Manager (NTLM) or Netlogon authentication handler, so as to implement an Active Directory, an LDAP directory that is not an Active Directory, or a cloud directory (e.g., the Azure Active Directory, the Okta Universal Directory, or Ping Identity). Server 24 comprises a communication interface, such as a NIC 36 or another network interface, and a processor 38. Processor 38 exchanges communication with client 22, and with other devices, via NIC 36.

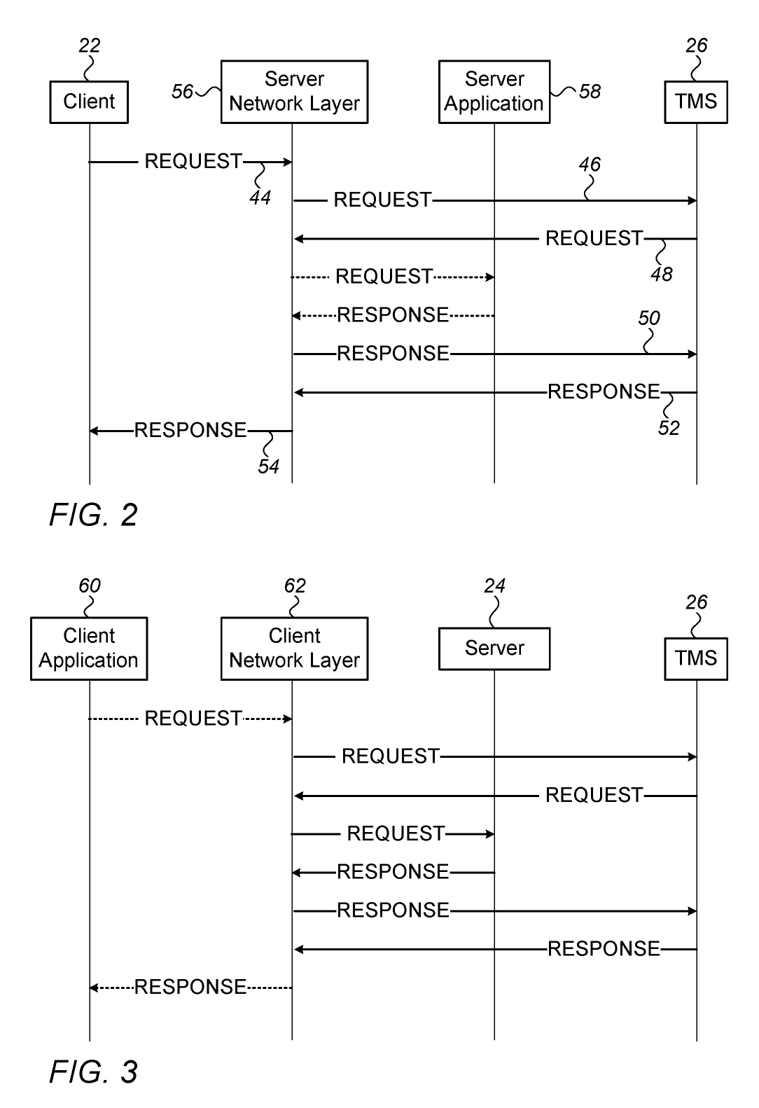

As further shown in FIG. 1, server 24 is configured to communicate with a traffic-management server (TMS) 26. More particularly, as described in detail below with reference to FIG. 2, server 24 may forward, to TMS 26, access requests received from client 22, instead of immediately processing these requests. (Typically, server 24 does not retain a copy of any forwarded requests.) Subsequently to receiving a forwarded request, TMS 26 may inspect the request, modify the request, and/or perform various other functions, and then return the request to server 24 for processing. Alternatively or additionally, server 24 may forward, to TMS 26, responses to the aforementioned access requests, instead of immediately communicating these responses to client 22. (Typically, server 24 does not retain a copy of any forwarded responses.) Subsequently to receiving a forwarded response, TMS 26 may inspect the response, modify the response, and/or perform various other functions, and then return the response to server 24 for forwarding to the client.

Advantageously, in some embodiments, as further described below with reference to FIG. 2, the software executed by processor 38 for performing the forwarding described herein is not specialized for forwarding to the TMS, but rather, is native to server 24. For example, Routing and Remote Access Service (RRAS) and/or destination network address translator (DNAT) software may be used to perform the forwarding described herein. Thus, it may not be necessary to install any third-party software on server 24. (Notwithstanding the above, if such an installation is allowed, the forwarding may be implemented by installing, on the server, a driver that handles incoming communication in accordance with rules that specify which communication is to be forwarded to the TMS, which is to be sent to the directory application, and which to another device.)

TMS 26 comprises a processor 34, configured to perform the various traffic-management functions described herein, along with a communication interface, such as a NIC 32 or another network interface, via which TMS 26 exchanges communication with other devices. In some embodiments, as shown in FIG. 1, TMS 26 does not belong to LAN 28, and server 24 communicates with TMS 26 over an external network 30, such as the Internet. (In such embodiments, the server may communicate with the TMS over a VPN tunnel, as further described below with reference to FIG. 2.) In other embodiments, TMS 26 resides within LAN 28.

In some embodiments, as further described below with reference to FIG. 3, access requests originating from client 22, and/or the responses to such requests, may be forwarded to TMS 26 by client 22, instead of by server 24. For example, client 22 may forward, to TMS 26, an access request that is directed to server 24 or to another server residing outside of LAN 28, instead of immediately communicating this request to the destination server. (Typically, client 22 does not retain a copy of the forwarded request.) Alternatively or additionally, client 22 may forward, to TMS 26, a response that was received from server 24 or from another server (typically without retaining a copy of the response), instead of immediately processing the response. After receiving, and processing, a request or response from client 22, TMS 26 may return the request or response to client 22.

(It is noted that, in the context of the present application, including the claims, a message is said to be “directed to” a particular device or application if the particular device or application is, per the original sender of the message, the intended recipient of the message.)

It is noted that LAN 28 may include any number of clients and servers, each of which may be configured to communicate with TMS 26 as described herein. It is further noted that system 20 may comprise a plurality of traffic-management servers 26, each of which may service any number of LANs and/or other types of local networks, by receiving and processing communication that is forwarded from these networks. In some embodiments, even devices that do not belong to a local network may forward access requests, and/or the responses to such requests, to TMS 26.

By virtue of the functionality described below with reference to the subsequent figures, TMS 26 may protect important network resources such as a remote server, a web application, a file-share, a hypervisor, a federation server, a remote access device (such as a remote desktop), a router, a firewall, a password-change service, a Linux server, a domain, a ticket, an encryption key, an application, a data storage device, or any other service on the computer network.

Notwithstanding the particular computing environment shown in FIG. 1, it is noted that the techniques described herein may be implemented in any suitable computing environment, including, for example, a cloud or hybrid cloud environment. For example, any one or more of the client, the server, and the TMS may belong to a virtual private cloud (VPC). In some embodiments, the TMS is implemented as a virtual machine. For example, using virtual hosting, one module implementing the functionality of the TMS and another module implementing the functionality of the client or server may be run on a single host, such that a single processor may execute the functionality of both the TMS and the client or server.

In general, each of the processors described herein may be embodied as a single processor, or as a cooperatively networked or clustered set of processors. Each of the processors described herein is typically a programmed digital computing device comprising a central processing unit (CPU), random access memory (RAM), non-volatile secondary storage, such as a hard drive or CD ROM drive, network interfaces, and/or peripheral devices. Program code, including software programs, and/or data are loaded into the RAM for execution and processing by the CPU and results are generated for display, output, transmittal, or storage, as is known in the art. The program code and/or data may be downloaded to the computer in electronic form, over a network, for example, or it may, alternatively or additionally, be provided and/or stored on non-transitory tangible media, such as magnetic, optical, or electronic memory. Such program code and/or data, when provided to the processor, produce a machine or special-purpose computer, configured to perform the tasks described herein.

### Forwarding from the Server to the TMS

Reference is now made to FIG. 2, which is a schematic illustration of a flow of communication between client 22, server 24 (FIG. 1), and TMS 26, in accordance with some embodiments of the present invention.

By way of introduction, it is noted that FIG. 2 depicts two separate layers of functionality of server 24 participating in the illustrated flow of communication. The first of these layers, a network layer 56, handles communication to and from server 24. Components of server 24 at the network layer may include one or more hardware elements, such as NIC 36, along with any relevant software installed on server 24, which, when executed by processor 38 (FIG. 1), performs the forwarding functionality described herein. In some embodiments, network layer 56 is implemented at least partly on a virtual machine.

In the context of the present application, including the claims, the “network layer” of a computing device refers to the lower-level subsystem of the computing device, including any combination of hardware and/or software components that handle and process network traffic. The network layer may include software that runs in the operating system kernel or in the user space, including, for example, software responsible for blocking or modifying received network packets. (This software may be described as “network-layer software,” and may additionally be said to “run at the network layer.” In some embodiments, this software includes hypervisor software.) Examples of network-layer components include network address translator (NAT) software, routing software, VPN client or server software, port-forwarding software, software firewalls, network interface controllers (NICs), drivers, and filter drivers.

The second of these layers, an application 58 that runs in the user space or kernel of the server, processes access requests from client 22. Application 58 may include, for example, an LDAP directory application, an NTLM or Netlogon authentication handler, or a webserver application. In some embodiments, application 58 runs on a virtual machine. Advantageously, as further described below, communication between the server and TMS 26 may be performed even without using application 58.

The flow of FIG. 2 begins with a first exchange of communication 44, in which a message belonging to an access request originating from the client and directed to application 58 is sent from the client to the server. For example, the message may belong to an authentication process (e.g., a Kerberos, NTLM, Netlogon, or LDAP authentication process) by virtue of belonging to an authentication request. As described in detail below, in response to such a message, and/or in response to another message belonging to a response to the authentication request, the TMS may intervene in the authentication process, e.g., by modifying a message belonging to the authentication process or requesting provision of additional authentication from the user who initiated the authentication request.

The request message is received at network layer 56 of the server. Subsequently, processor 38, by executing the relevant network-layer software (as described immediately below), decides to forward the message to TMS 26 before communicating the message to application 58. In response to this decision, processor 38, without communicating the message to application 58 (and, typically, without retaining a copy of the message), forwards the message from network layer 56, over LAN 28 and/or external network 30, to TMS 26, in a second exchange of communication 46. (It is noted that, for ease of description, the decision to forward the message, and the consequent forwarding, may alternatively be described as being performed by the network layer itself, or by the relevant components that belong to the network layer.) TMS 26 receives, and then processes, the forwarded message, as further described below.

The decision to forward the request from network layer 56, and the consequent forwarding of the request, may be implemented using any suitable technique. Such a technique may take advantage of the fact that certain ports are designated for access requests of certain types; hence, any communication received at one of these ports may be assumed to be an access request and may accordingly be forwarded (via NIC 36 (FIG. 1)) to the TMS.

As an example, a DNAT installed on the server may be configured to forward any communication received at a particular port to the TMS. Thus, in response to receiving a message belonging to an access request, the DNAT may set the destination IP address in the message to the IP address of the TMS, and then forward the message. For example, the DNAT may pass the message to port-forwarding software, which may then forward the message to the TMS. Alternatively, port-forwarding software or routing software may forward, to the TMS, any communication received at a particular port, even without the involvement of a DNAT. As yet another alternative, a driver installed on the server may be configured to identify any access requests in incoming communication, by inspecting the content of the incoming communication, and/or by ascertaining the port at which the communication was received. The driver may be further configured to forward any identified access requests to TMS 26.

In some embodiments, processor 38 opens a VPN tunnel with the TMS, and then forwards the request to the TMS through the VPN tunnel. For example, a DNAT may pass the message to a VPN interface, which may then forward the communication, through a VPN tunnel, to the TMS. Advantageously, this technique may facilitate retaining the IP address of the client in the forwarded message, such that the TMS may identify the client.

(It is noted that, in the context of the present application, including the claims, a processor (or network-layer software) may be said to “decide” to forward a particular message if the processor (or the network-layer software) initiates the forwarding, regardless of the method by which the forwarding is initiated. Thus, for example, even if the processor initiates the forwarding of a message by implementing a simple, preconfigured forwarding rule, such as a network address translation, the processor may be said to have “decided” to forward the message.)

Subsequently to receiving the forwarded request, the TMS processes the forwarded request. For example, TMS 26 may log relevant parameters of the request for monitoring purposes. Alternatively or additionally, the TMS may inspect relevant parameters of the request, such as the identity of the user who initiated the request, the resource to which access is requested, relevant network addresses included in the request, and the time of the request. Optionally, the TMS may further calculate a risk measure associated with the request, based on these parameters. If the parameters of the request indicate that the request should be denied—e.g., if the calculated risk measure exceeds a predetermined threshold—the TMS may close the connection between the TMS and the server, or simply refrain from returning the request to the server (i.e., drop the request), such that the server subsequently closes the connection between the server and the client. Alternatively, the TMS may decide that the request should be denied, but may refrain from implementing this denial until after inspecting the server's response to the request, as further described below.

In some embodiments, in response to processing the request, the TMS requests provision of authentication from the user for whom access is requested. For example, the TMS may decide, based on the parameters of the request (and, optionally, based on a risk measure calculated from these parameters and/or any of the other factors described above), that the user is required to resubmit a particular authentication factor, or to submit an additional authentication factor. The TMS may then request the required authentication responsively thereto. Alternatively, the TMS may request authentication, regardless of the content of the request.

To request that the user authenticate himself to the TMS, the TMS may communicate an appropriate message to the client (in the event that the user is using the client), or to another device, such as the user's smartphone, requesting that the user submit a password, a biometric factor (such as a fingerprint), proof of possession of a particular known device, or any other appropriate authentication factor. Subsequently, the TMS waits to receive the requested authentication factor. If the authentication factor is not received within a particular time interval, the TMS may close the connection, or simply refrain from returning the request to the server, as described above.

In other embodiments, the TMS may decide, based on the content of the request, that further authentication from the user is required, but may refrain from requesting this authentication until after inspecting the server's response to the request, as further described below.

Alternatively or additionally to performing the functions described above, the TMS may, in processing the request, modify the request, prior to returning the request to the server. For example, the TMS may modify the request to request a lower level of access than was originally requested, or to request access to a different resource from that which was originally requested. Alternatively, in the event that the request cannot be handled by application 58, due, for example, to the client using outdated software, the TMS may modify the request (e.g., by adding or removing particular fields), such that the request is compatible with application 58. (Especially in view of the above, it is noted that the techniques described herein may be applied even outside the context of computer-network security.)

Following the processing of the message belonging to the request (and assuming the TMS does not terminate the connection or decide to refrain from returning the request), the TMS returns the request message to the server in a third exchange of communication 48, typically over a separate connection from the connection used for second exchange of communication 46. The message (which, as described immediately above, may have been modified by TMS 26) is received at network layer 56, and is then communicated to application 58. Application 58 then generates a response to the request, this response being directed to the client (and in particular, to the application on the client that generated the request). Subsequently, application 58 communicates this response to network layer 56. (The dashed arrows between network layer 56 and application 58 indicate communication that is passed internally, within server 24.)

In some embodiments, the TMS returns the message under an identifier of the client, such that the returned request appears, to the server, to have been received from the client. For example, the TMS may return the message using the IP address of the client as the source IP address of the message. Alternatively or additionally, network layer 56 may format the request to appear to application 58 as if the request were received directly from the client. Advantageously, this may help obviate the need to make any changes to application 58 to facilitate the flow of communication depicted in FIG. 2.

Subsequently to receiving the response from the application, without communicating the response to the client (and, typically, without retaining a copy of the response), the network layer, in a fourth exchange of communication 50, forwards, to the TMS, the message belonging to the response, using any of the forwarding techniques described above. Since, as described above, third exchange of communication 48 typically occurs over a separate connection from the second exchange of communication, the network layer may readily ascertain that the response is to be forwarded to the TMS, rather than passed directly to the client. In the event that the request was returned to the server with the IP address of the client as the source IP address, the response is forwarded with the IP address of the client as the destination IP address.

The TMS receives the message belonging to the response. Subsequently, the TMS processes the received response, by logging the response for monitoring purposes, inspecting the content of the response, and/or performing other actions in response to the content of the response. For example, the TMS may ascertain that the response indicates that the request was granted and, in response thereto, and in response to previously having decided, based on the content of the request, to deny the request, modify the response to indicate that the request was denied. (Alternatively, the TMS may close the connection, or simply refrain from returning the response to the server.) Alternatively, in response to ascertaining that the response indicates that the request was granted, and in response to having previously decided (e.g., based on the content of the request) to request provision of authentication from the user, the TMS may request the authentication, as described above. Alternatively, the TMS may decide to request the provision of authentication based on relevant parameters of the response, and/or based on a risk measure based on these parameters, as described above for the access request. As yet another alternative, the TMS may request provision of authentication from the user whenever the response indicates that the request was granted. In response to not receiving the requested authentication, the TMS may modify the response to indicate that the request was denied, or to indicate that the client should send another access request.

Subsequently (assuming the TMS does not terminate the connection or decide to refrain from returning the response), the TMS returns the response to the server, in a fifth exchange of communication 52. The response is received at the network layer of the server. (As noted immediately above, the server may receive the response after the response has been modified by the TMS.) Subsequently, the server forwards the response, in a sixth exchange of communication 54, to the client (and in particular, to the application on the client that generated the request).

In some embodiments, the TMS, when processing a request and/or a response, considers the history of prior access requests by the current user and/or by other users. For example, the TMS may consider such data when deciding whether to require additional authentication from the user (e.g., when calculating a risk measure that is used for this decision). When incorporating this data into the decision-making process, the TMS may use either fixed logic or a machine-learned model. Alternatively or additionally, the TMS may receive indications from other security systems about suspicious or high-risk entities (e.g., users, clients, servers, or IP addresses), and consider this additional data when processing a request or a response. For example, the TMS may increase a risk measure that is calculated for a given request, in response to one or more parameters in the request matching an indication received from another security system.

It is noted that, in some cases, an access request or response thereto may include multiple messages, any one or more of which may be forwarded to TMS 26 as described herein.

### Forwarding from the Client to the TMS

Reference is now made to FIG. 3, which is a schematic illustration of an alternate flow of communication between client 22 (FIG. 1), server 24, and TMS 26, in accordance with some embodiments of the present invention.

By way of introduction, it is noted that FIG. 3 depicts two separate layers of functionality of client 22 participating in the illustrated flow of communication. The first of these layers, a network layer 62, handles communication to and from the client. Components of client 22 at the network layer may include one or more hardware elements, such as NIC 40, along with any relevant software installed on client 22, which, when executed by processor 42 (FIG. 1), performs the forwarding functionality described herein. In some embodiments, network layer 62 is implemented at least partly on a virtual machine.

The second of these layers, an application 60 that runs in the user space or kernel of the client, generates access requests, and receives and processes the responses to such requests. Examples of application 60 include a web browser, or any authentication package. In some embodiments, application 60 runs on a virtual machine. Advantageously, the forwarding functionality described hereinbelow may be performed even without any special configuration of application 60.

The flow in FIG. 3 is generally similar to the flow in FIG. 2, except for client 22, instead of server 24, performing the forwarding to TMS 26. Hence, only a brief description of this flow is provided below.

First, application 60 generates an access request, which is directed to the server (and in particular, to application 58 (FIG. 2) running on the server). This request is communicated, internally, to network layer 62. Subsequently, processor 42, by executing the relevant network-layer software, decides to forward the request to TMS 26 before communicating the request to server 24. In response to this decision, processor 42, without communicating the request to the server (and, typically, without retaining a copy of the request), forwards the request, from network layer 62, to the TMS. In forwarding the request, network layer 62 may use any suitable forwarding techniques, such as any of the techniques described above. (Processor 42, by executing the relevant network-layer software, may identify that the request is to be forwarded to the TMS based on the content of the request, and/or based on any ports that are specified in the request.)

Subsequently, the TMS processes the request, as described above with reference to FIG. 2, and then returns the request to the client. The client then passes this request to the server. Subsequently, the server generates a response to the request, this response being directed to application 60, and communicates this response to the client. The response is received at network layer 62. Without communicating this response to application 60 (and, typically, without retaining a copy of the response), network layer 62 forwards the response to the TMS. The TMS then processes the response and returns the response to network layer 62. Finally, network layer 62 communicates the response to application 60.

In some embodiments, the TMS returns the response under an identifier of the server, such that the returned response appears, to the client, to have been received from the server. For example, the TMS may use the IP address of the server as the source IP address of the response. Alternatively or additionally, network layer 62 may format the response to appear to application 60 as if the response were received directly from the server. Advantageously, this may help obviate the need to make any changes to application 60 to facilitate the flow of communication depicted in FIG. 3.

### Other Embodiments

In some embodiments, the server or client forwards only the request to the TMS, and the response is not forwarded to the TMS at all. (In other words, after the TMS processes the request and returns the request to the forwarding device, the response to the request may be sent directly from the server to the client.) Alternatively, the server or client may forward only the response to the TMS, and the request may not be forwarded to the TMS at all. (In other words, the request may be sent directly from the client to the server, after which the response may be forwarded to the TMS, processed by the TMS, and then returned to the forwarding device.) As yet another alternative, the client may forward the request and the server may forward the response, or vice versa. In some embodiments, a response is forwarded to the TMS only if the response indicates that the request was approved, and/or only if the response satisfies other predefined criteria.

As noted above in the Overview, in some embodiments, the forwarding techniques described herein are implemented solely in network-layer hardware, such that the processor of the server or client need not execute any network-layer software.

In alternate embodiments, the TMS resides inline, between the client and the server, such that neither the server nor the client need perform any forwarding. Thus, for example, in a LAN setting, the TMS may reside between a DC and the various other devices in the network that communicate authentication requests to the DC.

For example, the physical connection between the client and server may pass through the TMS, such that the TMS “sits on the wire.” For example, in a virtual network, the functionality of the TMS may be implemented on a virtual machine having two virtual adapters: one for communication with the server, and the other for communication with the client. Alternatively, the client may be configured to use the TMS as a proxy server for the server, and/or the server may be configured to use the TMS as a proxy server for the client. As yet another alternative, during the discovery process in which one of the devices requests the address of the other device, the IP address of the TMS may be returned. For example, a Domain Name System (DNS) for the network may be configured to return the IP address of the TMS in lieu of the IP address of the client or server. To help prevent direct communication between the client and server, users may be refused permission to change the relevant configurations, such as those of the client, server, or

DNS. Alternatively or additionally, firewall rules may be defined to block any direct communication between the devices. Such rules may be defined using a firewall that is native to one of the devices, or using a network firewall.

As yet another alternative, an agent installed on the server may perform at least some of the functionality of the TMS, such that a single processor may execute the functionality of both the TMS and the server.

### Decryption and Re-Encryption

As described above in the Overview, upon receiving an encrypted message belonging to an access request or to a response thereto, the TMS may decrypt the message prior to processing the message. Subsequently, in response to processing the message, the TMS may modify the message, as described above with reference to FIG. 2. Subsequently, the TMS may re-encrypt the message, and then communicate the message to the client or server, as appropriate. Alternatively, in the event that the message is not modified, the TMS may simply communicate the original message to the client or server, without first re-encrypting the message.

For messages encrypted using symmetric encryption protocols, the TMS may acquire the keys required for decryption from an administrator. Alternatively, an agent installed on the server may communicate the keys to the TMS, or the TMS may retrieve the keys from the server. For messages encrypted using asymmetric encryption protocols, the TMS may acquire both the required public key certificate and the required private key from an administrator or from the server, as described above for the symmetric-encryption protocols. Alternatively, the TMS may generate its own public key certificate. This certificate may then be signed, at the behest of an administrator, by the certificate authority for the network. Alternatively, the administrator may allow the TMS to act as a certificate authority, such that the TMS itself may sign the certificate.

### Implementing a Multi-Factor Authentication Policy

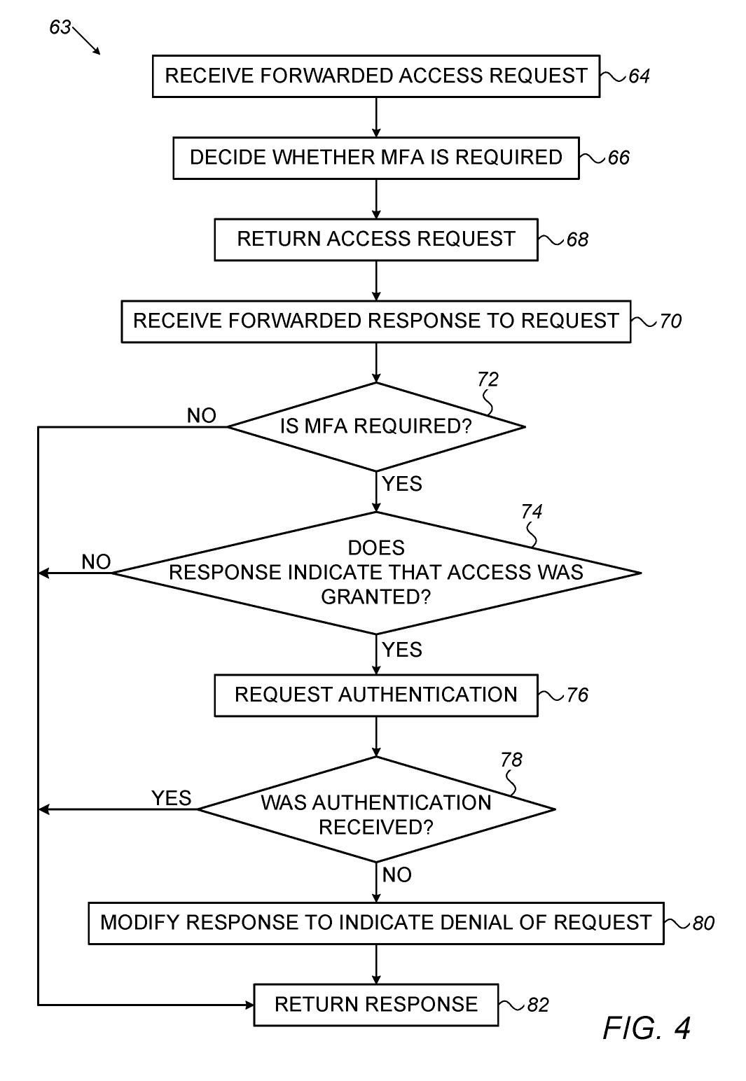

Reference is now made to FIG. 4, which is a schematic illustration of a flow diagram for a method 63 for implementing a multi-factor authentication (MFA) policy, in accordance with some embodiments of the present invention. (In general, the various steps in method 63 were already described above, with reference to the previous figures. As noted above with reference to the previous figures, many variations to method 63 are included within the scope of the present disclosure.)

First, at a request-receiving step 64, the TMS receives, from client 22 or server 24, a forwarded access request. Subsequently, at a deciding step 66, the TMS decides, based on the parameters of the request, whether multi-factor authentication (MFA) is required, i.e., whether the user is required to submit any authentication factors in addition to whichever authentication factors (if any) are already required by the server. (Alternatively, as described above, this decision may be deferred until the response to the access request is received.) Next, at a request-returning step 68, the TMS returns the request to the client or server. Subsequently, at a response-receiving step 70, the TMS receives, from the client or server, a forwarded response to the access request. The TMS then ascertains, at a first ascertaining step 72, whether the TMS previously decided (at deciding step 66) to require MFA. If yes, the TMS then ascertains, at a response-inspecting step 74, whether the response indicates that the requested access was granted. If not, or if MFA is not required, the TMS returns the response to the server or client, at a response-returning step 82. Otherwise, the TMS requests authentication from the user, at an authentication-requesting step 76.

Subsequently to requesting authentication, the TMS, at a second ascertaining step 78, ascertains whether the requested authentication was received (e.g., within a predetermined time interval). If yes, the TMS returns the response to the client or server, at response-returning step 82. Otherwise, the TMS, before returning the response, first modifies the response, at a response-modifying step 80, to indicate that the request was denied. (Alternatively, as noted above, the TMS may simply drop the response or close the connection, to indicate that the request was denied.)

### Health Tests

Typically, health tests are continually (e.g., periodically) performed, to verify that the TMS is handling traffic as required.

In the event that the server is configured to forward to the TMS, the server may initiate each health test, by passing a health-test request to the TMS. Subsequently to receiving such a request, and assuming the TMS is operating as required, the TMS communicates a test access-request message, which simulates a genuine access request, to the server. This message is received at the network layer of the server, and is then forwarded, from the network layer, to the TMS, as if this message were a genuine access request. The flow of communication then proceeds as in FIG. 2, with the TMS playing the role of the client, in addition to the usual role of the TMS.

In response to an unsuccessful health test—e.g., in response to the TMS not responding to communication within a predetermined time interval, or sending communication that is not readable—system 20 may adopt a failover configuration, in that the server or client may forward to a different traffic-management server. Alternatively, system 20 may adopt a fail open configuration, in that the server or client may simply cease forwarding access requests, and the responses to such requests, to any traffic-management server.

### System Architecture

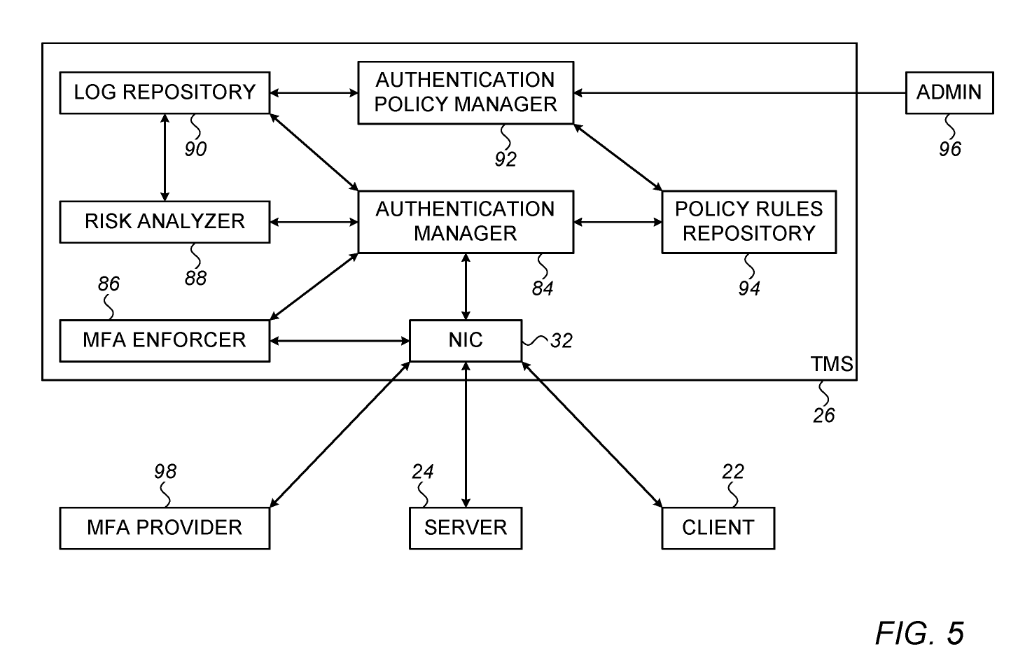

Reference is now made to FIG. 5, which is a schematic illustration of the internal architecture of TMS 26, in accordance with some embodiments of the present invention.

FIG. 5 shows NIC 32, various information repositories (stored, for example, on a hard drive), and various software modules that may be executed by processor 34 (FIG. 1). The various arrows in FIG. 5 indicate internal communication between these components, as well as communication between some of these components and external entities. Example functions that may be performed the components of the TMS are hereby described.

Access requests, and/or responses to access requests, may be received, at NIC 32, from any number of clients and/or servers. NIC 32 passes each of these received messages to an authentication manager 84. Authentication manager 84 then decrypts and analyzes the message, so as to identify the user for whom access is requested, the resource for which access is requested, and any other relevant details. The authentication manager may then decide whether additional authentication is required, e.g., as described above with reference to deciding step 66 of FIG. 4. To this end, the authentication manager may refer to policy rules stored in a policy rules repository 94. An example of such a rule is that a particular user (or class of users) must submit an additional authentication factor before the user is allowed to access a particular resource.

In some embodiments, prior to deciding whether additional authentication is required, the authentication manager passes the message details to a risk analyzer 88. Based on the details, risk analyzer 88 computes a risk measure that quantifies the estimated risk of the access being granted. This computation may utilize fixed logic or a machine-learned model. In some embodiments, such a model may be continually retrained, using the results of any required additional authentication steps.

To compute the risk measure, the risk analyzer may use information stored in a log repository 90. Log repository 90 may store, for example, logs of prior access requests, the manner in which each of these requests was handled, and whether access was ultimately granted. In addition to being used for the risk-measure calculation, this information may be used for auditing purposes.

Subsequently to calculating the risk measure, the risk analyzer passes the risk measure to the authentication manager. The authentication manager then decides whether additional authentication is required, in response to both the risk measure and the relevant policy rules.

The policy rules are typically defined by an administrator (“admin”) 96. To interact with the TMS for the purpose of defining the policy rules, administrator 96 may use an authentication policy manager 92, which may draw on information from the log repository. Each of the defined rules is stored by authentication policy manager 92 in the policy rules repository.

In response to deciding that additional authentication is required, the authentication manager instructs an MFA enforcer 86 to request the required authentication. MFA enforcer 86 then requests the authentication, e.g., as described above with reference to authentication-requesting step 76 of FIG. 4. For example, the MFA enforcer may, using the NIC, instruct a third-party MFA provider 98 to request an authentication factor from the user. Alternatively, the MFA enforcer may request the authentication factor directly, without the involvement of MFA provider 98. Upon receiving the authentication factor, the MFA enforcer passes an indication of the user's proof of possession of the authentication factor to the authentication manager. The authentication manager then ascertains whether the indication is valid, e.g., as described above with reference to second ascertaining step 78 of FIG. 4.

It is emphasized that the particular architecture shown in FIG. 5 is provided by way of example only, and that numerous other architectures are included within the scope of the present invention. Each of these other architectures may include any suitable combination of hardware and/or software components, which may be configured to communicate with each other in any suitable way so as to perform the functionality described herein.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. Apparatus, comprising:
a communication interface; and
a processor, configured to:
run a request-destination application, and
without using the request-destination application:
receive a message belonging to an access request or to a response to the access request, the access request originating from a request-origin device and directed to the request-destination application,
subsequently to receiving the message, forward the message, via the communication interface, to a traffic-management server before communicating the message to a destination of the message,
subsequently to forwarding the message, receive the message from the traffic-management server, and
subsequently to receiving the message from the traffic-management server, communicate the message to the destination of the message.

2. The apparatus according to claim 1, wherein the message belongs to the access request, such that the destination of the message is the request-destination application.

3. The apparatus according to claim 1, wherein the message belongs to the response to the access request, such that the destination of the message is the request-origin device.

4. The apparatus according to claim 1, wherein the processor is configured to forward the message by executing software that is not specialized for forwarding to the traffic-management server.

5. The apparatus according to claim 4, wherein the software includes Routing and Remote Access Service (RRAS) software.

6. The apparatus according to claim 4, wherein the software includes a destination network address translator (DNAT), and wherein the processor is configured to, using the DNAT, set a destination Internet Protocol (IP) address in the forwarded message to an IP address of the traffic-management server.

7. The apparatus according to claim 1, wherein the processor is further configured to open a Virtual Private Network (VPN) tunnel with the traffic-management server, and wherein the processor is configured to forward and receive the message through the VPN tunnel.

8. The apparatus according to claim 1, wherein the access request includes an authentication request, and wherein the request-destination application includes a directory application.

9. The apparatus according to claim 1, wherein the request-destination application is selected from the group of applications consisting of: a Kerberos Key Distribution Center, an NT Local Area Network Manager (NTLM) authentication handler, a Netlogon authentication handler, and a Lightweight Directory Access Protocol (LDAP) directory application.

10. The apparatus according to claim 1, wherein the processor is configured to forward the message by executing network-layer software.

11. Apparatus for intervening in an authentication process between a request-origin device and a directory application, the apparatus comprising:
a communication interface; and
a processor, configured to:
receive, via the communication interface, an encrypted message belonging to the authentication process by virtue of belonging to (i) an authentication request originating from the request-origin device and directed to the directory application, or (ii) a response to the authentication request, and
without using the directory application:
decrypt the message,
subsequently to decrypting the message, process the message, and
in response to processing the message, intervene in the authentication process.

12. The apparatus according to claim 11, wherein the directory application is run on a directory server, and wherein the processor does not belong to the request-origin device and does not belong to the directory server.

13. The apparatus according to claim 12, wherein the processor is configured to intervene in the authentication process by:
modifying the message,
subsequently to modifying the message, re-encrypting the message, and
subsequently to re-encrypting the message, sending the message to a device selected from the group of devices consisting of: the request-origin device, and the directory server.

14. The apparatus according to claim 13, wherein the message belongs to the authentication request, and wherein the processor is configured to send the message to the directory server using an Internet Protocol (IP) address of the request-origin device as a source IP address of the message.

15. The apparatus according to claim 11, wherein the processor is configured to intervene in the authentication process by requesting provision of authentication from a user who initiated the authentication request.

16. The apparatus according to claim 11, wherein the authentication process is in accordance with a protocol selected from the group of protocols consisting of: Kerberos, NT Local Area Network Manager (NTLM), Netlogon, and Lightweight Directory Access Protocol (LDAP).

17. Apparatus for intervening in an authentication process between a request-origin device and a directory application, the apparatus comprising:
a communication interface; and
a processor, configured to:
receive a message belonging to the authentication process by virtue of belonging to (i) an authentication request originating from the request-origin device and directed to the directory application, or (ii) a response to the authentication request, the message being encrypted using an encrypted Active Directory authentication protocol, and
without using the directory application:
in response to receiving the message, process the message, and
in response to processing the message, request, via the communication interface, provision of authentication from a user who initiated the authentication request.

18. The apparatus according to claim 17, wherein the directory application is run on a directory server, and wherein the processor does not belong to the request-origin device and does not belong to the directory server.

19. The apparatus according to claim 17, wherein the protocol is selected from the group of protocols consisting of: Netlogon, Lightweight Directory Access Protocol over Secure Sockets Layer (LDAPS), and Flexible Authentication Secure Tunneling (FAST).

20. A method, comprising:
receiving a message belonging to an access request or to a response to the access request, the access request originating from a request-origin device and directed to a request-destination application; and
without using the request-destination application:
subsequently to receiving the message, forwarding the message to a traffic-management server before communicating the message to a destination of the message;
subsequently to forwarding the message, receiving the message from the traffic-management server; and
subsequently to receiving the message from the traffic-management server,
communicating the message to the destination of the message.

21. The method according to claim 20, wherein the message belongs to the access request, such that the destination of the message is the request-destination application.

22. The method according to claim 20, wherein the message belongs to the response to the access request, such that the destination of the message is the request-origin device.

23. The method according to claim 20, wherein forwarding the message comprises forwarding the message by executing software that is not specialized for forwarding to the traffic-management server.

24. The method according to claim 23, wherein the software includes Routing and Remote Access Service (RRAS) software.

25. The method according to claim 23, wherein the software includes a destination network address translator (DNAT), and wherein the method further comprises, using the DNAT, setting a destination Internet Protocol (IP) address in the forwarded message to an IP address of the traffic-management server.

26. The method according to claim 20, further comprising opening a Virtual Private Network (VPN) tunnel with the traffic-management server, wherein forwarding the message comprises forwarding the message through the VPN tunnel, and wherein receiving the message comprises receiving the message through the VPN tunnel.

27. The method according to claim 20, wherein the access request includes an authentication request, and wherein the request-destination application includes a directory application.

28. The method according to claim 20, wherein the request-destination application is selected from the group of applications consisting of: a Kerberos Key Distribution Center, an NT Local Area Network Manager (NTLM) authentication handler, a Netlogon authentication handler, and a Lightweight Directory Access Protocol (LDAP) directory application.

29. The method according to claim 20, wherein forwarding the message comprises forwarding the message by executing network-layer software.

30. A method for intervening in an authentication process between a request-origin device and a directory application, the method comprising:
receiving an encrypted message belonging to the authentication process by virtue of belonging to (i) an authentication request originating from the request-origin device and directed to the directory application, or (ii) a response to the authentication request; and
without using the directory application:
decrypting the message,
subsequently to decrypting the message, processing the message, and
in response to processing the message, intervening in the authentication process.

31. The method according to claim 30, wherein the directory application is run on a directory server, and wherein intervening in the authentication process comprises:
modifying the message;
subsequently to modifying the message, re-encrypting the message; and
subsequently to re-encrypting the message, sending the message to a device selected from the group of devices consisting of: the request-origin device, and the directory server.

32. The method according to claim 31, wherein the message belongs to the authentication request, and wherein sending the message comprises sending the message to the directory server using an Internet Protocol (IP) address of the request-origin device as a source IP address of the message.

33. The method according to claim 30, wherein the message belongs to the authentication request, and wherein receiving the message comprises receiving the message from the request-origin device.

34. The method according to claim 33, wherein receiving the message from the request-origin device comprises receiving the message, by a traffic-management server, from the request-origin device by virtue of the request-origin device using the traffic-management server as a proxy for the directory server.

35. The method according to claim 33, wherein receiving the message from the request-origin device comprises receiving the message, by a traffic-management server, from the request-origin device by virtue of a Domain Name System (DNS) returning an Internet Protocol (IP) address of the traffic-management server in lieu of an IP address of the directory server.

36. The method according to claim 30, wherein the directory application is run on a directory server, and wherein receiving the message comprises receiving the message from the directory server.

37. The method according to claim 36, wherein the message belongs to the authentication request, and wherein receiving the message from the directory server comprises receiving the message, by a traffic-management server, from the directory server by virtue of the directory server forwarding the message to the traffic-management server in response to receiving the message from the request-origin device.

38. The method according to claim 36, wherein the message belongs to the response, and wherein receiving the message from the directory server comprises receiving the message from the directory server with an Internet Protocol (IP) address of the request-origin device as a destination IP address of the message.

39. The method according to claim 30, wherein intervening in the authentication process comprises intervening in the authentication process by requesting provision of authentication from a user who initiated the authentication request.

40. The method according to claim 30, wherein the authentication process is in accordance with a protocol selected from the group of protocols consisting of: Kerberos, NT Local Area Network Manager (NTLM), Netlogon, and Lightweight Directory Access Protocol (LDAP).

41. A method for intervening in an authentication process between a request-origin device and a directory application, the method comprising:
receiving a message belonging to the authentication process by virtue of belonging to (i) an authentication request originating from the request-origin device and directed to the directory application, or (ii) a response to the authentication request, the message being encrypted using an encrypted Active Directory authentication protocol; and
without using the directory application:
in response to receiving the message, processing the message, and
in response to processing the message, requesting provision of authentication from a user who initiated the authentication request.

42. The method according to claim 41, wherein the protocol is selected from the group of protocols consisting of: Netlogon, Lightweight Directory Access Protocol over Secure Sockets Layer (LDAPS), and Flexible Authentication Secure Tunneling (FAST).
